(19) United States
(12) Patent Application Publication
(10) Pub. No.: US 2003/0164881 A1
(43) Pub. Date: Sep. 4, 2003

(54) Portable information terminal device

(75) Inventors: Haruki Ohe, Tokyo (JP); Kiyosi Toma, Tokyo (JP)

Correspondence Address: Pillsbury Winthrop LLP, Intellectual Property Group, Ninth Floor, East Tower, 1100 New York Avenue, N.W., Washington, DC, 20005-3918, US

(73) Assignee: Nidec Copal Corporation, Tokyo (JP)

(21) Appl. No.: 10/375,283

(22) Filed: Feb. 27, 2003

(30) Foreign Application Priority Data
Mar. 1, 2002 (JP) P2002-055656

(51) Int. Cl. H04N 5/222

(52) U.S. Cl. 348/207.99

(57) ABSTRACT

A portable information terminal device according to the present invention includes a display portion capable of displaying information, a camera including a lens and a CCD (Charge-Coupled Device), which are used to shoot a subject, and a body portion for retaining the display portion and the camera, and light-emitting diodes that emit illuminating light for close-up shooting are arranged around the lens of the body in a plurality, whereby a sufficiently bright shot image can be secured by the illuminating light brought about by the light-emitting diodes even if close-up shooting is carried out on a subject such as a name card, a document surface, etc.

### BACKGROUND OF THE INVENTION

1. Field of the Invention

The present invention relates to a portable information terminal device such as a portable telephone unit, a portable information terminal, etc., (hereinafter, portable telephone units and portable personal computers, etc., are generally called “portable information terminal device”), and in particular, relates to a portable information terminal device provided with a camera that is able to photograph (or shoot) an image of an operator, or surrounding objects and scenes.

2. Description of the Related Art

In recent years, a wireless communications system such as a Wideband Code Division Multiple Access (W-CDMA) has been developed. A portable telephone unit or a portable personal computer, etc., which are provided with a camera (so-called mobile camera) using an image pickup device like a CCD and are able to transmit and receive image signals, have been developed in line with the transfer rate of data being increased by the communications system.

In the portable information terminal devices, natural light has been utilized as illumination when shooting (or photographing) an image of an operator himself or a surrounding scene, etc., by a camera on board.

However, when shooting an object (or a subject) such as, for example, name (or business) cards, documents on which text information is written, etc., by a camera carried on the above-described conventional portable information terminal device, shooting (or photographing) is carried out in a state where the camera is approached to the subject until the shooting distance becomes several centimeters.

However, if close shooting (or close-up shooting) is carried out by the conventional portable information terminal device, natural light that enters onto the shooting surface of the subject is interrupted by the portable information terminal device itself since the lens is very close to the subject, whereby such a problem arises, in which a light quantity necessary to photograph (that is, subject brightness) cannot be obtained, and the photographed image becomes dark.

Also, even if a conventional strobe is provided in the portable information terminal device, as shown in FIG. 1, since the distance D between the lens G and the subject A is close, several centimeters, a light beam (strobe light) LB of the strobe S is not irradiated onto the surface of the subject A, and a problem arises, in which the shooting image becomes dark as in the case of natural light.

The present invention has been developed in view of the above-described points, and it is therefore an object of the present invention to provide a portable information terminal device by which, even if close-up shooting is carried out, a sufficiently bright image can be obtained by a simple operation.

### SUMMARY OF THE INVENTION

In order to achieve the above-described object, a portable information terminal device according to the present invention comprises a display portion capable of displaying information, a camera including a lens and an image pickup device, which are used to photograph (or shoot) a subject, and a body portion for retaining the display portion and the camera, wherein the body portion is provided with an illuminating means for emitting illuminating light for shooting in the vicinity of the lens.

According to this structure, since illuminating light is emitted by the illuminating means when shooting a subject (for example, a name (or business) card, surface of a document, other objects disposed close to the camera) disposed particularly close to the camera by the camera carried on a portable information terminal device, a sufficiently bright shot image can be obtained.

In the above-described structure, the illuminating means may employ such a structure in which a plurality of illuminating means are arranged around the lens.

According to this structure, since the illuminating means is provided and arranged so as to surround the lens, the surface of a subject can be uniformly illuminated without any offset, whereby a uniformly bright shot image free from any unevenness can be brought about.

The above-described structure further includes a controlling means that controls a light emission timing of the illuminating means, and the controlling means may employ such a structure in which the illuminating means is turned on when the brightness of a subject (light quantity from a subject) is lower than a prescribed level.

According to this structure, when the subject is dark, the illuminating means is automatically turned on (the lighting thereof is controlled by the controlling means) to emit illuminating light toward the subject. Therefore, shooting can be carried out with no cumbersome operation required.

The above-described structure further includes a controlling means that controls a light emission timing of the illuminating means, and the controlling means may employ such a structure in which the illuminating means is turned on for only a shorter time than an exposure time of an image pickup device when shooting a still image.

According to this structure, since the illuminating means is turned on only in a period of a necessary time at prescribed timing where a still image is shot by the camera, the illuminating light can be efficiently irradiated to the subject while effectively suppressing the power consumption, and a bright shot image can be brought about.

The above-described structure may employ such a structure in which the illuminating means is light-emitting diodes.

According to this structure, since light-emitting diodes are used as an illuminating means, the surrounding of the lens is integrated, and the entirety thereof can be made smaller.

### BRIEF DESCRIPTION OF THE DRAWINGS

FIG. 1 is a side elevational view showing a case where close-up shooting is carried out by a camera of a prior art portable telephone unit;

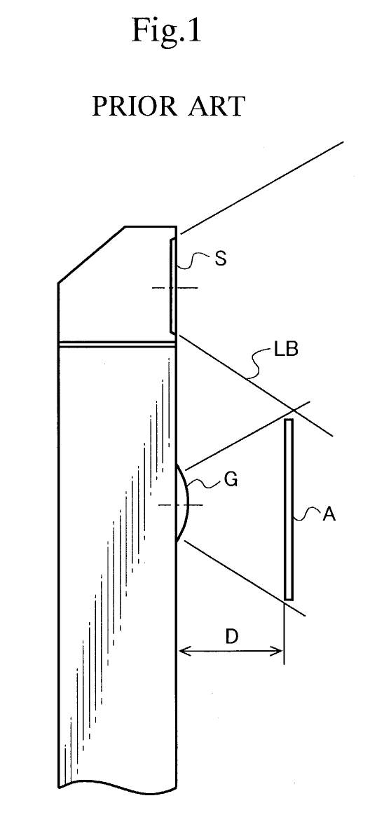

FIG. 2 is a front elevational view showing one embodiment of a portable telephone unit, which is a portable information terminal device according to the present invention;

FIG. 3 is a partially sectional view of a portable telephone unit shown in FIG. 2;

FIG. 4 is a side elevational view showing a case where close-up shooting is carried out by a camera of a portable telephone unit shown in FIG. 2;

FIG. 5 is a block diagram showing a control circuit of a portable telephone unit shown in FIG. 2;

FIG. 6 is a timing chart showing a control sequence;

FIG. 7 is a rear side view showing another embodiment of a portable telephone unit, which is a portable information terminal device according to the present invention;

FIG. 8 is a side elevational view showing a case where close-up shooting is carried out by a camera of a portable telephone unit shown in FIG. 7; and

FIG. 9 is a perspective view showing still another embodiment of a portable telephone unit, which is a portable information terminal device according to the present invention.

### DESCRIPTION OF THE PREFERRED EMBODIMENTS

Hereinafter, a description is given of preferred embodiments of the present invention with reference to the accompanying drawings.

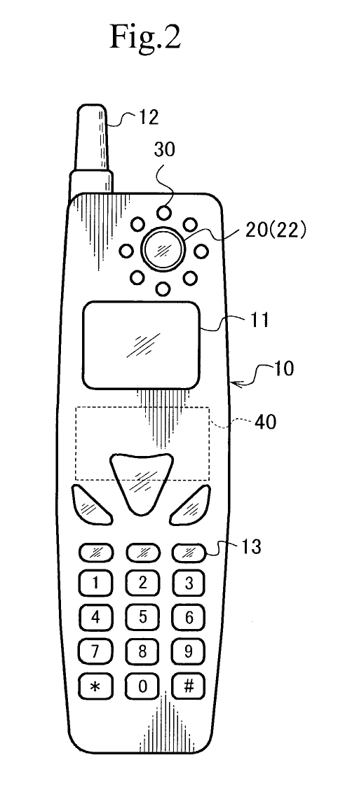

A portable telephone unit, which is one embodiment of a portable information terminal device according to the present invention is, as shown in FIG. 2, provided with a body 10 that defines the outer profile, a display portion (liquid crystal monitor) 11 that is installed on a surface of the body 10 and is able to display information concerning various types of transmission and receiving, an antenna 12, various types of operation buttons 13, a camera 20 for shooting (or photographing) a subject, light-emitting diodes 30 which are an illuminating means for emitting illuminating light to a subject, and a control circuit 40 that is disposed in the body 10 and acts as a controlling means for performing various types of control.

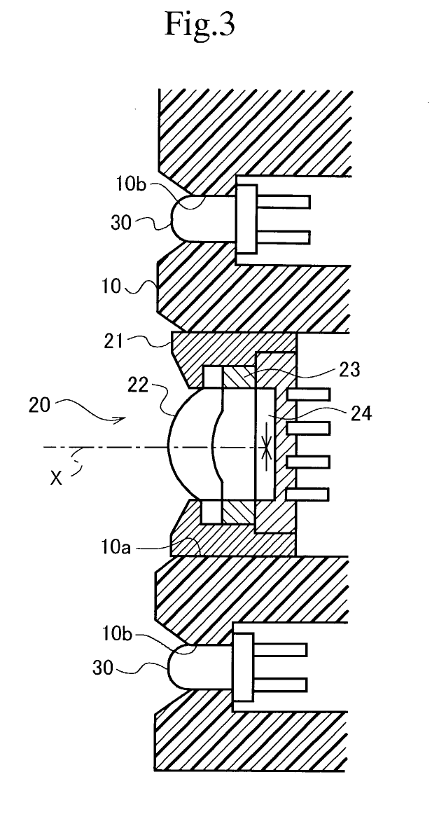

As shown in FIG. 3, the camera 20 is integrally formed as a module including a cylindrical lens frame 21, a resin-made lens 22 fixed on the lens frame 21, a CCD 24 acting as an image pickup device, which is disposed at the rear side of the lens 22 in the optical axis direction X via a spacer, etc. That is, the camera 20 forms a single focus type optical system. Further, the camera 20 is fixed at the body 10 by fitting the lens frame 21 in a fitting hole 10a.

The light-emitting diode (LED) 30 is such that a light-emitting element is sealed with dome-shaped transparent resin as shown in FIG. 2 and FIG. 3. A plurality of light-emitting diodes 30 are annularly arranged around the lens 22 (herein, eight diodes). The light-emitting diodes 30 are fixed at the body 10 by the transparent resin portion being fitted in the fitting holes 10b. In addition, a battery (not illustrated) carried on the portable information terminal device is used as a power source of the light-emitting diodes 30.

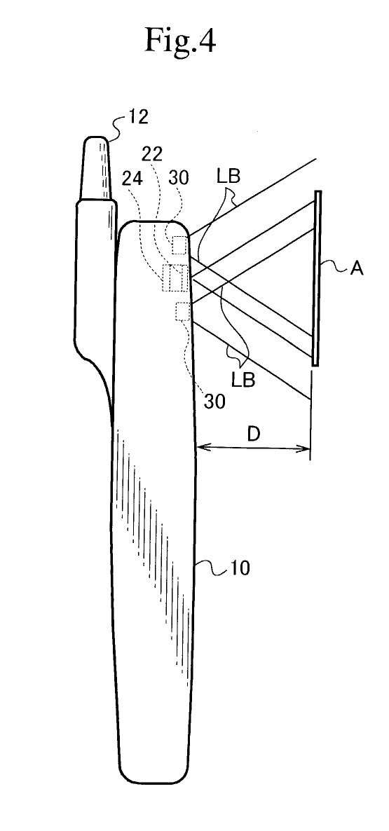

Herein, a description is given of the mutual relationship between the light-emitting diodes 30, the camera 20 (lens 22 and CCD 24) and a subject A when close-up shooting is carried out on the subject A such as a name (or business) card. As shown in FIG. 4, in the case that the subject A is located at a distance D apart by several centimeters from the camera 20 (lens 22), since illuminating lights LB emitted from the respective light-emitting diodes 30 are made incident onto the surface of the subject A so as for the respective illuminating lights LB to overlap to each other, the shooting surface of the subject A is lit up uniformly without any unevenness.

Thereby, when close-up shooting is carried out by the camera 20 on the subject A, a bright image free from any unevenness can be obtained.

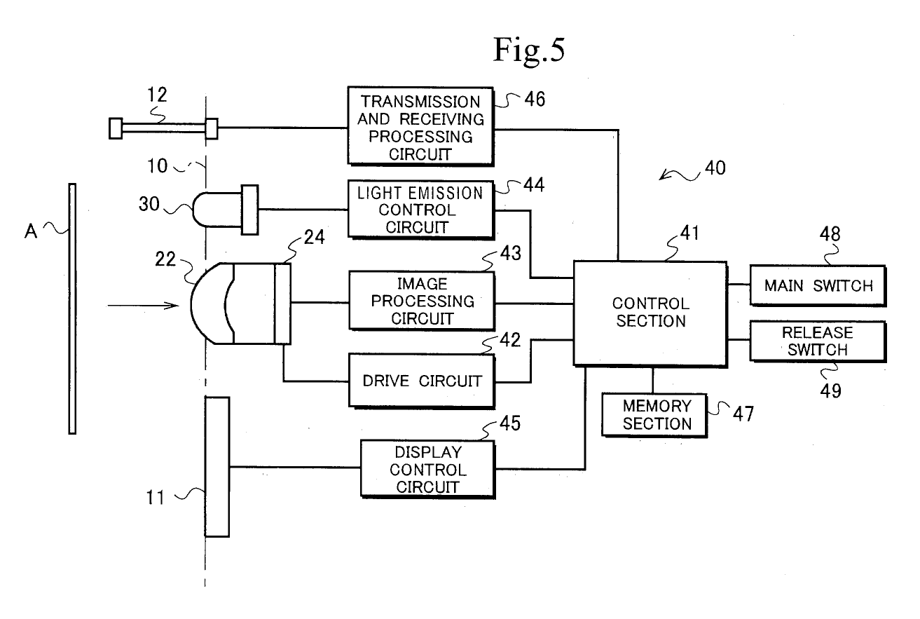

As shown in FIG. 5, the control circuit 40 is composed of a control section 41 such as a CPU that performs the entire control by outputting various types of control signals, a drive circuit 42 that turns on and off power supply to the CCD 24, an image processing circuit 43 for processing image signals picked up by the CCD 24, a light emission control circuit 44 for controlling a light emission of the light-emitting diodes 30, a display control circuit 45 for controlling display of information with respect to the display portion 11, a transmission and receiving processing circuit 46 for transmitting and receiving signals through the antenna 12, a memory section 47 for storing various types of information, a main switch 48 of the camera 20, and a release switch 49 of the camera 20, etc.

The light emission control circuit 44 controls the light emission timing (light emission timing and light emission time, etc.) of the light-emitting diodes 30. In close-up shooting, when the brightness of a subject A, that is, the quantity of light reflected from a subject A is lower than a prescribed level, the light-emitting diodes 30 are caused to emit light based on a control signal from the control section 41.

Also, in close-up shooting of a still image, the light emission control circuit 44 causes the light-emitting diodes 30 to emit light only in a period of shorter time than an exposure time of the CCD 24 on the basis of a control signal from the control section 41.

The control section 41 carries out a process of calculation (or judgement) on the basis of various detection signals and command signals by operation and outputs various control signals. For example, on the basis of image information obtained through the CCD 24 and the image processing circuit 43, the control section 41 judges the light quantity (subject brightness) level of reflection light from the subject A.

Next, when the light quantity (brightness) level is lower than a prescribed level, the control section 41 outputs a control signal, which causes the light-emitting diodes 30 to emit light, toward the light emission control circuit 44. Thus, the control section 41 outputs control signals regarding the timing, on which the light-emitting diodes 30 are caused to emit light, and period of time of the light emission, etc., to the light emission control circuit 44.

Herein, although the control section 41 carries out direct judgement on the basis of the image information by the CCD 24 in order to detect the light quantity (brightness) level of the subject A, an exclusive photometric device and photometric circuit, etc., may be provided to measure the light quantity level of the subject A, wherein the measurement information is transmitted to the control section 41.

The main switch 48 turns on and off power supply to the CCD 24 via the control section 41 and the drive circuit 24 when shooting by the camera 20 is carried out. In the ON state, a moving image can be shot by the CCD 24. On the other hand, in the OFF state, no shooting is enabled.

Further, the main switch 48 is incorporated as a part of the operation button 13.

The release switch 49 is operated when shooting a still image of the subject A in a state where the main switch 48 is turned on, and power supply to the CCD 24 is interrupted when a prescribed period of time elapses since the switch is operated (for example, a push operation). The period of time becomes an exposure time of the CCD 24 when shooting a still image.

In addition, the release switch 49 is incorporated as a part of the operation button 13.

Next, a description is given of a shooting operation when shooting a subject by the camera 20 in the above-described portable information terminal device.

First, as the main switch 48 of the camera 20 is turned on, power is supplied to the CCD 24, wherein a moving image can be shot by the camera 20. In this state, when an subject such as an operator or a surrounding scene is shot apart by several tens of centimeters from the camera 20 (lens 22), the subject is not interrupted by the body 10 and natural light is not accordingly interrupted, whereby a sufficiently bright shot image can be obtained without irradiating light by the light-emitting diodes 30.

On the other hand, when close-up shooting is carried out on a subject A such as a name (or business) card, etc., to obtain a still image at a position distant by several centimeters from the camera 20 (lens 22), the body 10 is approached to and located at the subject A as shown in FIG. 4, first, the control section 41 judges whether or not the light quantity (brightness) of the subject A is not more than a prescribed level, on the basis of the image information obtained by the image processing circuit 43.

Next, when an operator operates the release switch 49 where the control section 41 judges that the light quantity (brightness) of the subject A exceeds the prescribed level, the control section 41 outputs a control signal of not lighting the light emission control circuit 44, or, without issuing any control signal, emits a control signal (a drive signal of turning off after a prescribed period of time elapses) of commanding an exposure time of the CCD 24 to the drive circuit 42. Therefore, the close-up shooting is completed by the CCD 24, and a still image of the subject A can be obtained through the image processing circuit 43.

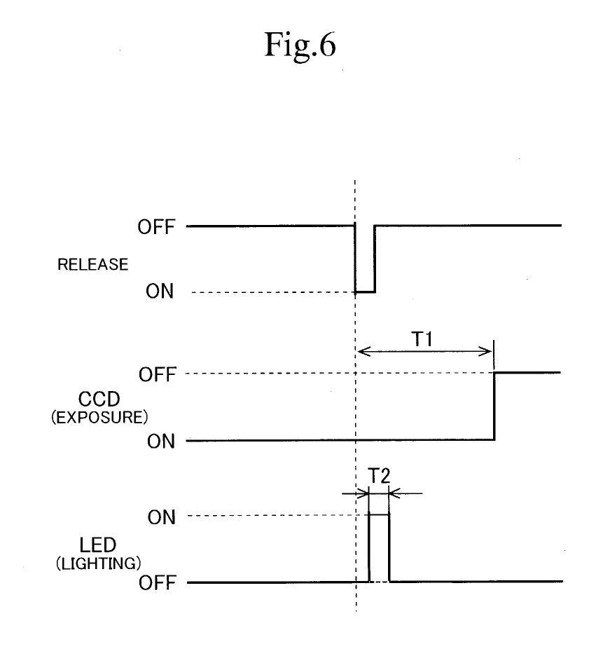

On the other hand, when an operator operates the release switch 49 as shown in FIG. 6 where the control section 41 judges that the light quantity (brightness) of the subject A is lower than the prescribed level, first, the control section 41 outputs to the light emission control circuit 44 a lighting command signal by which the light-emitting diodes 30 are turned on at a prescribed timing for only a prescribed period of time T2, and simultaneously, the control section 41 outputs a control signal (a drive signal of turning off after the prescribed period of time T1 elapses) for setting the exposure time T1 of the CCD 24 to the drive circuit 42.

Herein, as shown in FIG. 6, the light emission timing of the light-emitting diodes 30 is set after the exposure is started by the CCD 24 and the light emission time T2 of the light-emitting diodes 30 is shorter than the exposure time by the CCD 24. Thus, by setting the light emission time T2 shorter than the exposure time T1, the lighting current of the light-emitting diodes 30 can be increased, and sufficient illuminating light can be secured. At the same time, power consumption of the battery can be saved. Thereby, in close-up shooting where natural light is interrupted, a bright shot image can be obtained.

After that, when a transmission operation is carried out by the operation button 13 in order to transmit a shot still image, a transmission command signal is outputted from the control section 41 to the transmission and receiving processing circuit 46, and the signal is transmitted to a portable information terminal device of a receiver.

Also, in the above-described control sequence, although the CCD 24 is turned off after a prescribed period of time T1 elapses since the release is operated, it may be turned off after a prescribed period of time T1 elapses since the CCD 24 is initialized by being once turned off and turned on again on the basis of a release operation.

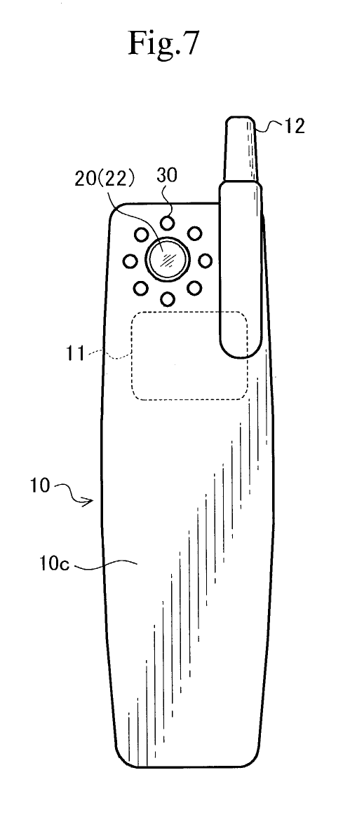

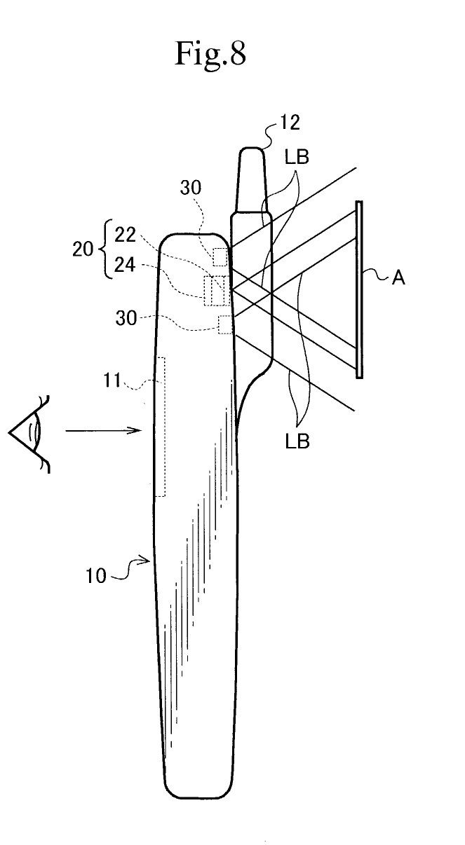

FIG. 7 and FIG. 8 show a portable telephone unit, which is another embodiment of a portable information terminal device according to the present invention.

In the portable telephone unit, a camera 20 (lens 22) and a plurality of light-emitting diodes 30 (herein, eight diodes) are provided on the rear side 10c of the body 10, and all other structures are identical to the above-described embodiment.

Herein, a description is given of the mutual relationship between the light-emitting diodes 30, the camera 20 (lens 22), and a subject A such as a name (or business) card, etc., in close-up shooting of the subject A. As shown in FIG. 8, where the subject A is disposed at a distance D apart by several centimeters from the camera 20 (lens 22), illuminating lights LB emitted from the respective light-emitting diodes 30 enter the surface of the subject A so that the respective lights overlap to each other as described above, whereby the shooting surface of the subject A is illuminated uniformly free from any unevenness or shade.

Therefore, where the subject A is shot in a close-up state by the camera 20, an image free from any unevenness or shade can be obtained.

In addition, in a state where the close-up shooting is carried out, if the control section 41 controls the shooting image of the subject A so as to be displayed on the display portion 11 via the display control circuit 45, an operator is able to check the state of the image to be shot through the display portion 11 in advance.

Accordingly, when there is a positional deviation regarding the shooting range of the subject A, it is possible to correct the positional deviation while checking the image displayed on the display portion 11. By operating the release switch 49 if there is no further problem thereafter, where the control section 41 judges, as described above, that the light quantity (brightness) from the subject A is lower than a prescribed level, the light-emitting diodes 30 are turned on at a prescribed timing for only the period of prescribed time T2 via the light emission control circuit 44, and the close-up shooting is carried out.

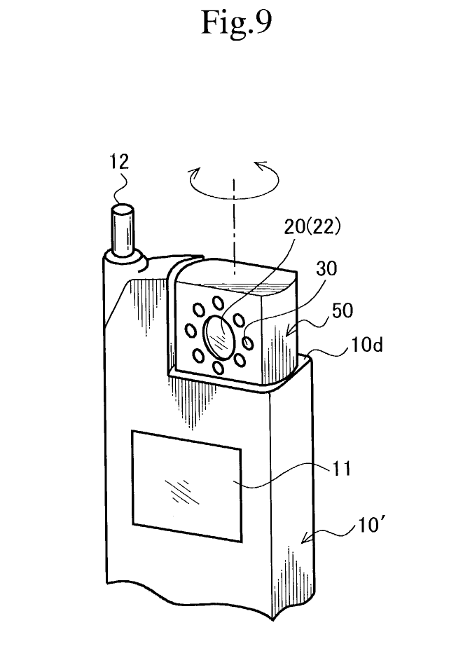

FIG. 9 is a perspective view showing a portable telephone unit of still another embodiment of a portable information terminal device according to the present invention. In the portable telephone unit, as shown in FIG. 9, a dent portion 10d is formed on the upper end portion of the body 10′, and a camera unit 50 is rotatably connected to the dent portion 10d.

The camera unit 50 accommodates the above-described camera 20 (lens 22, CCD 24, etc.), and a plurality of the above-described light-emitting diodes 30 (herein, eight diodes) are annularly arranged around the lens 22.

Also, since the camera unit 50 is turned roughly 180 degrees with respect to the body 10′, it may be turned to in both directions of the surface of the body 10′, which is the same side of the display portion 11, and the rear side of the body 10′, which is the opposite side of the display 11.

Therefore, only by adjusting the orientation of the camera unit 50, the camera unit 50 has a structure in which both functions of the portable telephone unit shown in FIG. 2 described above and that shown in FIG. 7 are concurrently provided.

In the embodiment, as described above, since the light-emitting diodes 30 are turned on in close-up shooting, a bright shot image can be brought about.

In the above-described embodiments, although light-emitting diodes 30 are illustrated as an illuminating means for emitting illuminating light for shooting, the illuminating means is not limited thereto. EL (electroluminescence) devices or an EL panel, or other illuminating means may be employed if these are comparatively small and may be disposed around the lens 22.

In addition, in the above-described embodiments, such a structure in which eight light-emitting diodes 30 are annularly arranged around the lens 22 is illustrated as a structure of providing the light-emitting diodes 30 in the vicinity of the lens 22. However, the structure is not limited thereto. Four light-emitting diodes 30 may be disposed in cross directions, the concept of which is included in “annularly”, around the lens 22, two light-emitting diodes 30 may be disposed so as to place the lens 22 therebetween, or only one light-emitting diode 30 may be provided in the vicinity of the lens 22 as long as sufficient illuminating light can be secured.

Also, in the above-described embodiments, such a structure in which an illuminating means is controlled so as to emit light when carrying out close-up shooting of a still image is shown. However, the illuminating means may be controlled so as to emit light in close-up shooting of a moving image as long as a sufficient power source can be secured.

Further, the above-described embodiments show a structure in which an illuminating means is caused to emit light in close-up shooting. However, in shooting other than the close-up shooting, the illuminating means may be caused to emit light in response to the light quantity of a subject.

Still further, the above-described embodiments show a portable telephone unit as a portable information terminal device in which an illuminating means is provided around the lens 22. However, a portable information terminal device is not limited to the portable telephone unit. A similar structure may be employed in a portable personal computer.

In addition, in the above-described embodiments, a single-focus type optical system having one lens 22 is shown as a camera 20. The optical system is not limited to the camera 20. Such a structure in which the above-described illuminating means is provided may be employed in a variable power lens optical system having a plurality of lenses.

As described above, according to a portable information terminal device of the present invention, by providing an illuminating means for emitting illuminating light for shooting in the vicinity of a lens to constitute a camera for shooting a subject, since illuminating light is emitted by the illuminating means when shooting a particularly close subject (for example, a name (or business) card, a document surface, or other objects disposed in the vicinity), a sufficiently bright shot image can be obtained. Also, by annularly arraying a plurality of illuminating means around the lens, the surface of a subject can be lit up uniformly without any unevenness, whereby a shot image having uniform brightness without any unevenness or shade can be brought about.

Also, by turning on the illuminating means when the light quantity (brightness of a subject) from a subject is lower than a prescribed level, since the illuminating means is automatically turned on and is irradiated onto the subject where the subject is dark, shooting can be carried out without any cumbersome operation.

Still further, in shooting, since the illuminating means is devised so as to be turned on for a shorter period of time than the exposure time of an image pickup device, it is possible to efficiently irradiate illuminating light onto a subject while suppressing power consumption.

What is claimed is:

1. A portable information terminal device comprising:
a display portion capable of displaying information;
a camera including a lens and an image pickup device, which are used to shoot a subject; and
a body portion for retaining the display portion and the camera;
wherein the body portion is provided with an illuminating means for emitting illuminating light for shooting in the vicinity of the lens.

2. The portable information terminal device as set forth in claim 1, wherein the illuminating means is annularly arranged in a plurality around the lens.

3. The portable information terminal device as set forth in claim 1, further including a control means for controlling light emission timing of the illuminating means, wherein the controlling means turns on the illuminating means when the brightness of a subject is lower than a prescribed level.

4. The portable information terminal device as set forth in claim 1, further including a control means for controlling light emission timing of the illuminating means, wherein the control means turns on the illuminating means only for a shorter period of time than an exposure time of the image pickup device in shooting a still image.

5. The portable information terminal device as set forth in claim 1, wherein the illuminating means is a light-emitting diode.
